(19) United States
(12) Patent Application Publication
(10) Pub. No.: US 2009/0132462 A1
(43) Pub. Date: May 21, 2009

(54) DISTRIBUTED METADATA EXTRACTION

(75) Inventor: Stephan Szabo, San Francisco, CA (US)

Correspondence Address: Trellis Intellectual Property Law Group, PC, 1900 EMBARCADERO ROAD, SUITE 109, PALO ALTO, CA, 94303, US

(73) Assignees: SONY CORPORATION, Tokyo (JP); SONY ELECTRONICS INC., Parkridge, NJ (US)

(21) Appl. No.: 11/942,556

(22) Filed: Nov. 19, 2007

(51) Int. Cl. G06F 17/30

(52) U.S. Cl. 707/1; 707/E17.001

(57) ABSTRACT

Particular embodiments generally relate to distributed metadata extraction. In one embodiment, metadata may be extracted for content. A plurality of engines may be provided that include different capabilities for extracting metadata. These engines may be distributed in one or more devices. Distributed metadata extraction may be performed using the engines in the one or more devices. To perform the distributed extraction, coordination may be needed. Different engines may extract different types of metadata. Thus, a list of capabilities for the engines may be provided to a coordinator. The coordinator may then determine a graph that describes and organizes different capabilities for different engines. When content is received, the coordinator may determine if metadata should be extracted for the content. Then, the coordinator uses the graph to determine an interconnection flow to extract the metadata.

### BACKGROUND

Particular embodiments generally relate to computing and more specifically to distributed metadata processing.

Metadata may be used to facilitate the understanding, use, and management of data. With the proliferation of different kinds of digital data, such as images, audio, video, etc., extracting metadata from the digital data may provide very useful information about the data. Conventionally, applications that extract metadata are configured to perform a single task. That is, an application may be able to extract a certain kind of metadata, such as one application can extract the creation date and time for a file and another can extract facial region information from an image. These applications may be computationally expensive and may not be appropriate for all devices. For example, a personal digital assistant may not be able to process large amounts of digital data to determine facial region metadata for the data. When devices are not able to extract the metadata, the metadata may not be extracted at all and is not available to the device. Accordingly, devices lose the ability to use the knowledge provided by metadata. Further, any other devices do not have access to the metadata if it is not extracted.

### SUMMARY

Particular embodiments generally relate to distributed metadata extraction. In one embodiment, metadata may be extracted for content. A plurality of engines may be provided that include different capabilities for extracting metadata. These engines may be distributed in one or more devices. Distributed metadata extraction may be performed using the engines in the one or more devices.

To perform the distributed extraction, coordination may be needed. Different engines may extract different types of metadata. Also, some engines may use the results generated by other engines in the extraction of metadata. Thus, a list of capabilities for the engines may be provided to a coordinator. The coordinator may then determine a graph that describes and organizes different capabilities for different engines. When content is received, the coordinator may determine if metadata should be extracted for the content. Then, the coordinator uses the graph to determine an interconnection flow to extract the metadata. For example, it is possible that some engines may be able to extract the metadata but some engines may not. In one example, the engine that can extract the metadata may be on a different device from a device in which the coordinator and the content reside. The coordinator then sends the content to the determined engine to have the metadata extracted from the content. Extracting the metadata may be a complicated process that involves many different engines that may have to act on the content to fully extract the desired metadata. In this case, the interconnection flow is used to monitor the state of the metadata extraction and to guide which engines should process the content in which order. Thus, metadata may be extracted in a distributed manner where different engines that include different capabilities may process the content. This allows the extraction of metadata that previously may not have been extracted.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a system for performing distributed metadata extraction.

FIG. 2 depicts a more detailed example of devices according to one embodiment.

FIG. 3 depicts a more detailed example of a coordinator.

FIG. 4 depicts a simplified flowchart of a method for performing metadata extraction.

FIG. 5 depicts an example of a flowchart for coordinating the metadata extraction process according to one embodiment.

### DETAILED DESCRIPTION OF EMBODIMENTS

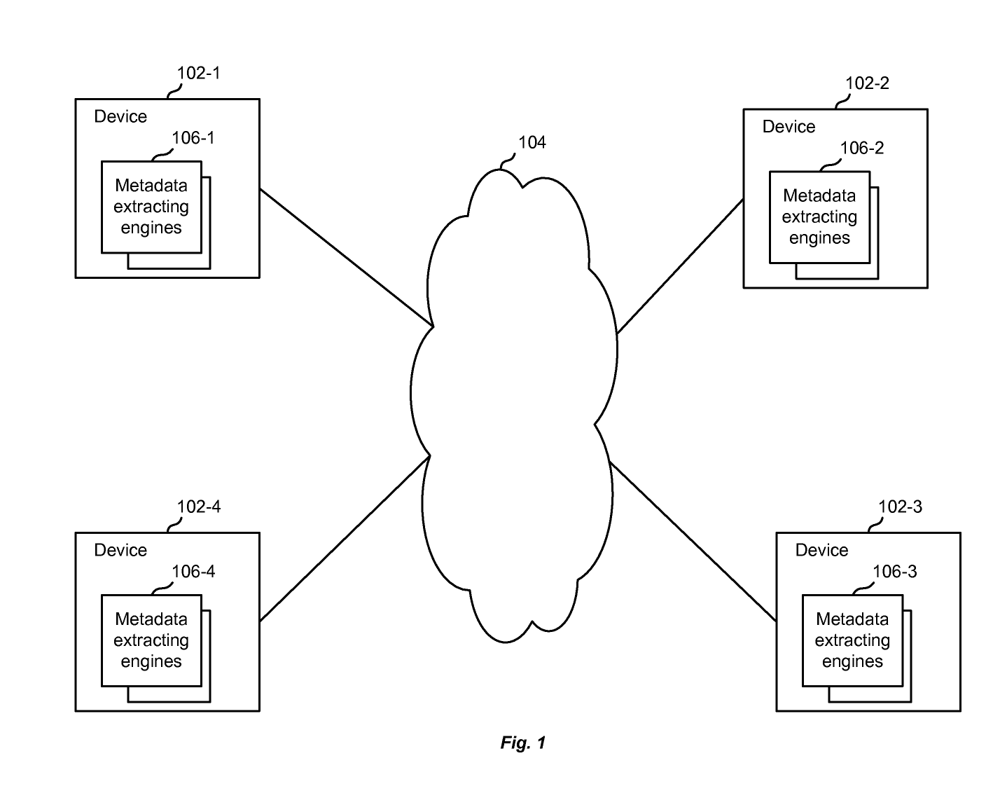

FIG. 1 depicts an example of a system 100 for performing distributed metadata extraction. As shown, a plurality of devices 102 is provided. Devices 102 may communicate through one or more networks 104. Each device 102 includes zero or more metadata extracting engines 106 that are configured to extract metadata from content. For example, some devices 102 may not have metadata extracting engines 106 but may store content and/or use metadata that is extracted. Other devices 102 may include any number of metadata extracting engines 106.

Devices 102 may be any computing device. For example, devices 102 may include personal computers, workstations, mainframes, laptop computers, etc. Also, devices 102 may include media devices, such as televisions, digital video disc (DVD) players, video game consoles, set top boxes, digital cameras, etc. In one embodiment, devices 102 may be any computing device that has processing capability.

Devices 102 may communicate through network 104. Network 104 may include a local area network (LAN), wide area network (WAN), the Internet, a wireless network, a Bluetooth connection, a wired connection, etc. Although one network 104 is shown, it will be understood that multiple networks may be used to communicate.

Engines 106 are configured to extract metadata from content. Metadata may be any information about content. Content may be any data, such as digital data. Examples of content include audio, video, audio/video, images, or any other data. The content may be carried in a resource that may be any storage medium, such as a file. An item of metadata may describe an individual datum, content item, or collection of data that includes multiple content items. Metadata can either describe the content itself (e.g., the video in the file shows a boy playing football), the resource storing the content (e.g., name and size of a file), or provide any other information about data.

Metadata may provide useful information, such as, if a camera is used to take a photographic image, metadata may include the date the photograph was taken and details of the camera settings. This metadata may be extracted from the data. Also, when a resource is a computer file, the metadata may include the name of the file and its length. Once the metadata is extracted, the information provided by the metadata may be used for other purposes or by other applications to improve processing.

Metadata may be extracted in different ways. For example, extracting metadata may mean metadata stored with the content is extracted. Also, metadata may be generated based on the content. For example, the mood of the content may be determined. Thus, when the term “extracted” is used, metadata may be generated for content or retrieved from the content.

Different engines 106 may have different capabilities. For example, engine 106-1 may be able to extract the mood of content and engine 106-2 may be able to perform facial recognition to determine facial regions in an image. Accordingly, if device 102-1 needs to have facial recognition performed, its own engine 106-1 could not do this. However, particular embodiments allow device 102-1 to communicate with device 102-2 to have facial recognition performed by engine 106-2.

The process of extracting metadata may be more complicated than one communication between devices, however. For example, many different engines 106 may be able to perform certain portions of the actions that need to be performed to ultimately extract the metadata. For example, metadata for an image, such as the camera used to take the picture and camera settings may need to be extracted by one engine 106, and then facial recognition may need to be performed on the picture by another engine 106. Thus, a chain of events needs to be coordinated where a first engine 106 processes the content to extract metadata and then a second engine 106 processes the output of first engine 106 to determine second metadata. The chain of events may include any number of engines 106. Thus, device 102 may coordinate a flow to extract the metadata.

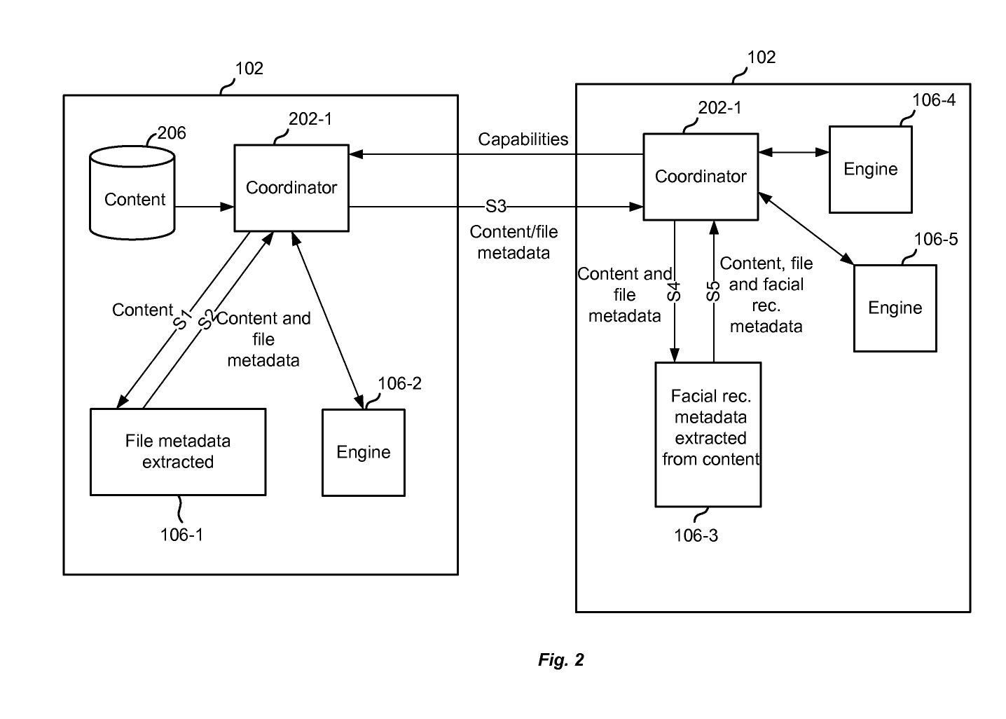

A more detailed example of the process flow will now be described. FIG. 2 depicts a more detailed example of devices 102 according to one embodiment. As shown, two devices 102-1 and 102-2 are provided; however, it will be understood that any number of devices 102 may be used. Each device 102 includes a coordinator 202 and one or more engines 106.

Coordinator 202 is configured to coordinate which metadata extraction actions should be performed. In one embodiment, each device 102 may include a single coordinator 202 that manages metadata extraction processes for it. In other embodiments, any number of coordinators 202 may be provided in device 102. Also, coordinators 202 do not have to be located in devices 102. Rather, a central coordinator 202 may coordinate metadata extraction for multiple devices 102. Further, a coordinator 202 may act as a coordinator for another device 102. For example, coordinator 202-1 may act as a coordination for device 102-2.

Devices 102 may include content, which is stored in storage 206. Each device 102 may include its own content. Also, devices 102 may receive content from other devices 102 for processing.

Device 102 may include any number of engines 106. Engines 106 may be components of an application or applications that are configured to perform metadata extraction. For example, different engines 106 may be configured to perform different metadata extractions. In one example, engine 106-1 may be able to extract metadata from an image file and engine 106-3 may be able to perform facial recognition on the image. Coordinator 202 may coordinate which content is sent to which engine 106 based on the capabilities of the engine and also manage the interconnection flow of content/metadata between engines. For example, within device 102-1, coordinator 202 may first send content to engine 106-1 for processing. After engine 106-1 outputs the processed content and extracted metadata, coordinator 202 may then send it to engine 106-3 for processing.

Devices 102 may be different, such as device 102-1 may be a camera and device 102-2 may be a personal computer. These devices include different processing power and capabilities. Conventionally, devices 102 did not communicate to coordinate extraction of metadata. However, particular embodiments provide an interface that allows devices 102 to communicate to have metadata extracted. Devices 102 each may understand a particular way of interacting with each other (via http to another machine of this sort, via file system operations to the OS, via http/soap to network services) with a preferred interface of one of those. These methods are generally known and standardized. Also, devices may have some very specific interface, such as a proprietary interface. In the cases where the interface is known, a uniform interface is used to allow devices to communicate to extract metadata. In other cases, an adapter that works with the device or service may be used to communicate with it to extract metadata. Coordinator 202 may manage the communications to have the metadata extracted. In one example, coordinator 202-1 may receive information for the capabilities for engines 106. In device 102-1, engines 106-1 and 106-2, which are internal to device 102-1, may broadcast their capabilities to coordinator 202-1. For example, coordinator 202 may receive the configurations for each engine and may then keep track of which capabilities engines 106-1 and 106-2 are able to perform. Also, the configurations may be preset on devices 102.

The processing of content to extract metadata may also be performed inter-device, such as between device 102-1 and device 102-2. In this case, coordinator 202-1 may receive the capabilities for engines 106-3, 106-4, and 106-5. Coordinator 202-1 may then generate a graph that indicates which capabilities each engine 106 can perform. This graph may be used to coordinate the processing of content among various engines 106.

In one example shown in FIG. 2, at S1, coordinator 202-1 sends content to engine 106-1, which can extract file metadata from the content. The file metadata may be the name of the file and when it was taken. The content and file metadata may be output at S2. Coordinator 202-1 then determines that the output should be processed by engine 106-3 to extract facial region metadata and the content and file metadata may be sent to coordinator 202-2 at S3. The content and file metadata is sent to engine 106-3, which extracts facial region metadata at S4. The content, file metadata, and facial region metadata may then be output and may be sent back to device 102-1, stored, sent to another device, processed more, etc. Accordingly, a process to perform distributed metadata extraction is provided where devices 102 of different capabilities and processing power may be used to extract metadata from content.

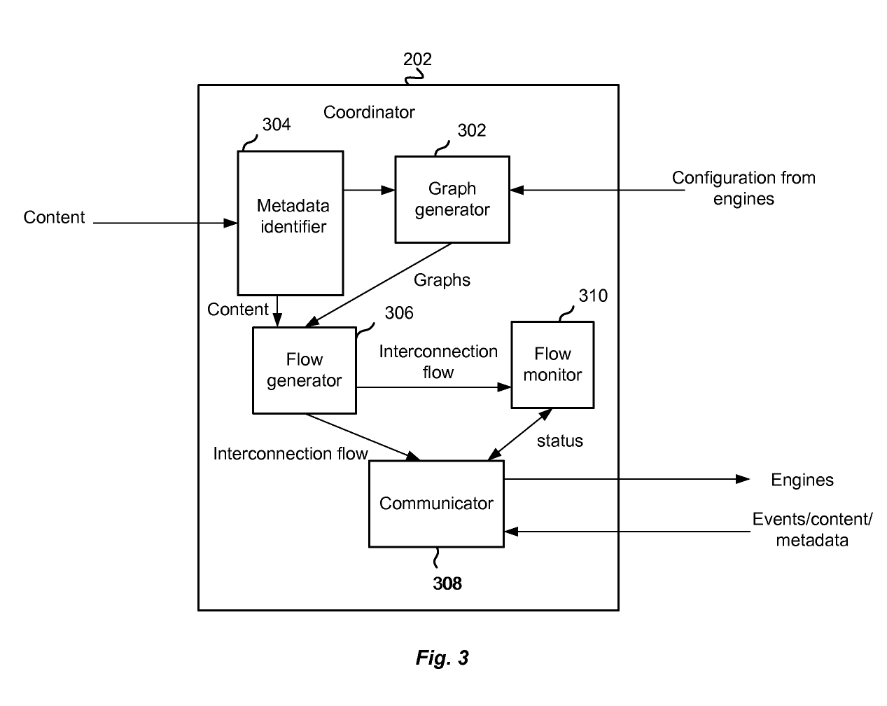

A more detailed example of coordinator 202 will now be described in FIG. 3. A graph generator 302 is configured to receive configurations from engines 106. The configurations indicate capabilities for each engine 106. A graph may then be generated from the configurations. The graph may organize the capabilities according to engines. In one example, the graph may be a tree-like structure that lists engines and their capabilities. It will be understood that the capabilities may be organized in other structures.

A metadata identifier 304 is configured to receive content and determine if metadata should be extracted. For example, metadata identifier 304 might identify which metadata should be extracted. In one example, for an image, metadata identifier 304 may determine that information about the camera and camera parameters should be extracted in addition to extracting facial region metadata. In other examples, metadata identifier 304 may determine that mood information should be extracted from an audio file.

Metadata identifier 304 may use a rules-based engine to determine what metadata should be extracted. The rules may specify types of content and which metadata should be extracted. Also, the rules may be personalized to different devices 102 or user preferences. For example, different users may want different metadata extracted, such as one user may want to know the camera parameters used to take a picture and another user may want to have facial recognition performed.

A flow generator 306 is configured to generate a flow to have the metadata extracted. Flow generator 306 receives the graph from graph generator 302 and the content from metadata identifier 304. Because metadata extraction may be a multi-step process, flow generator 306 may need to analyze the graph to determine how content should be processed to extract metadata. For example, sometimes metadata extraction may be performed in parallel or in series, i.e., some metadata extraction processes may be interdependent and some can be performed at any time. Thus, flow generator 306 may generate a state machine that may indicate which engines 106 should process which metadata and in what order.

A communicator 308 then communicates with engines 106 to process the metadata according to the flow. Communicator 308 may communicate with engines 106 that are resident within its device or may communicate with other engines 106 in external devices. For example, communicator 308 may communicate through network 104 to a different device. If communicator 308 communicates with a different device, a message may be sent to another coordinator 202, which can then coordinate the processing of the content with an engine 106.

As metadata is being processed, different events may occur. For example, when processing is finished by an engine 106, an event may be output indicating what has been processed. Further, the content and extracted metadata may also be output. Flow monitor 310 is configured to monitor the events and to determine which steps need to be further taken. For example, flow monitor 310 may use the flow generated to determine which engines 106 should be contacted next. In one example, flow monitor 310 may determine that engine 106-1 has processed the content and extracted metadata. Then, it is determined that communicator 308 should communicate with engine 106-3 to have the output of engine 106-1 processed. Further, in parallel to this, engine 106-2 may be contacted to process the content and extract metadata. This process may be ongoing until the metadata that is needed is extracted.

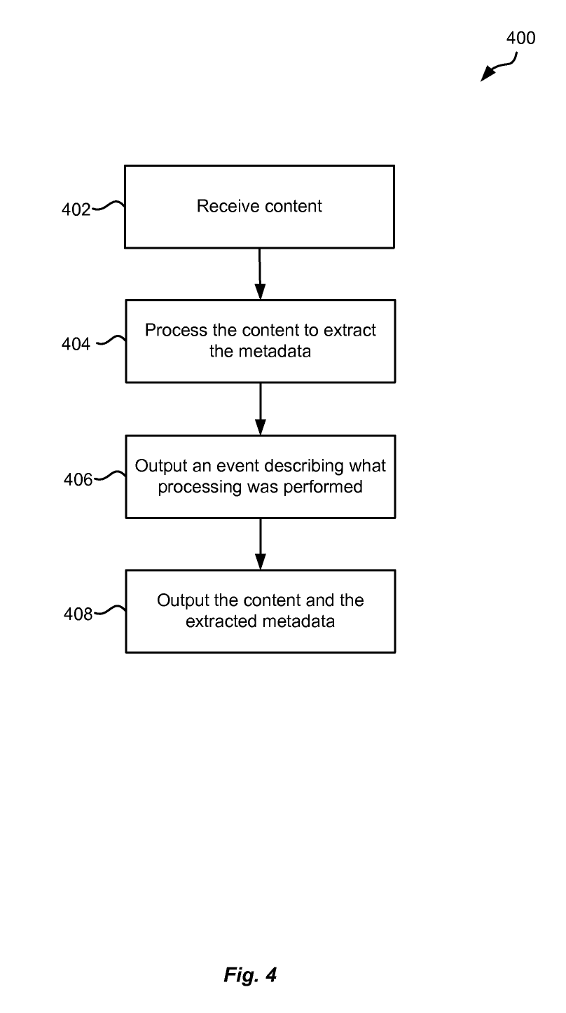

FIG. 4 depicts a simplified flowchart 400 of a method for performing metadata extraction. In step 402, engine 106 receives content. In step 404, engine 106 processes the content to extract the metadata. Each engine 106 may be pre-configured to process different kinds of metadata. The processing to extract metadata may be different depending on the engine used. For example, metadata included in a file may be extracted. Also, the content may be analyzed to extract the metadata, such as facial regions may be extracted in an image.

In step 406, an event describing what processing was performed is output. This event may indicate what action was performed, when it was performed, and/or the result. This may allow coordinators 202 to determine what the next steps in the metadata extraction process should be performed. Also, the event may be sent to different coordinators 202. For example, the coordinator that requested the metadata extraction may be contacted.

Step 408 also outputs the content and the extracted metadata. For example, the content and metadata may be sent back to a device 102 that requested the metadata extraction. However, in some cases, devices 102 that requested the metadata be extracted may not need the extracted metadata. For example, the device may not have the processing power to use the metadata. However, a device may have requested that the metadata be extracted because the metadata might be useful for another device. In this case, the content and metadata may be stored in storage 206 for use by another device, or the content and metadata may be sent to a third device 102.

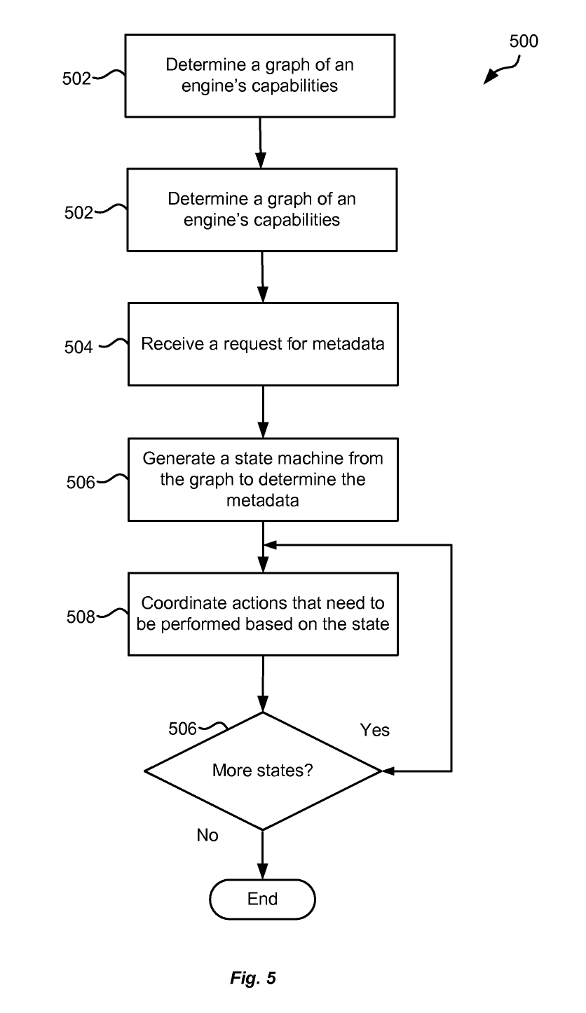

FIG. 5 depicts an example of a flowchart 500 for coordinating the metadata extraction process according to one embodiment. Step 502 gathers the list of engines, requirements, and capabilities to generate a model that organizes the capabilities for engines 106 that are available.

Step 502 takes the requirements and capabilities for engines 106 and generates a graph using data interdependencies to make the directional dependencies associated with processing that needs to be performed by engines and topologically sorts it.

Step 504 receives a request for metadata. For example, content may be received and an indication of which metadata should be identified is provided. Step 506 generates a new graph based on the graph from step 502 containing the subset of processing required to service the request for metadata received in step 504.

Step 508 then generates a state machine from the graph to determine the metadata. The state machine encodes the details of how to deal with interdependencies associated with processing that needs to be performed by engines 106. This may provide a flow as to which engines 106 should process the content in which order.

Step 510 then coordinates actions that need to be performed based on the state. For example, an engine 106 associated with the state is contacted to process the content to extract metadata. In one example, actions may be performed in parallel. Thus, actions for two states may be performed in parallel and different engines 106 may be contacted to perform the metadata extraction for content.

In step 512, it is determined if more states are included. If so, the process reiterates to step 510 where another state is determined. For example, metadata may have been extracted from the content to produce a file that includes the new metadata and content. The new file may then be sent to another engine in step 508 for additional metadata extraction. This process continues until the state machine reaches a completion state.

Accordingly, a process to distribute metadata processing is provided. A framework allows different devices 102 to communicate to process the metadata. A standard interface that allows engines 106 of different devices 102 to interact and process metadata may be provided. For example, coordinators 202 may be provided in devices 102 that coordinate the processing of content and metadata.

An example will now be described that is for illustrative purposes and is not limiting. Different devices 102 may be connected to a television. For example, a set top box, video game console, and personal computer may be connected to the television. Each device may have different capabilities. Images may be displayed on the television and may be downloaded to the personal computer. The personal computer may be able to extract metadata from the images, such as the creation time and camera parameters used to capture the image. However, the personal computer does not have an application that can extract faces from the images. Thus, the personal computer may communicate with the video game console, which may include a powerful graphics processor that can perform facial recognition. The video game console can then perform facial recognition to determine where the faces are in the pictures. The facial recognition metadata may then be sent back to the personal computer.

The personal computer uses the content to create a photo album using the facial recognition metadata. For example, the faces may be extracted from the content based on the facial recognition data and an album is created. The facial recognition metadata may indicate the number of faces and where they are in the image and thus allow the personal computer to extract the faces for the photo album. The metadata that is extracted by the personal computer may be used in creating the album. For example, the metadata may include the creation time of the photo, whether the photo is a portrait or a landscape, etc. Positioning the image in the photo album may use whether the photo is a portrait or a landscape to properly determine a frame and position the face in the frame. Thus, in this example, multiple devices that were able to perform different metadata extraction tasks were able to communicate to perform the metadata extraction process. This method is very powerful and allows multiple devices have metadata extracted that previously could not be. For example, a personal computer may not have been able to have the facial recognition performed. The process is automated and can be coordinated using the interconnection flow.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that which is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method for distributed metadata extraction, the method comprising:
determining content;
determining a list of capabilities for a plurality of engines, wherein engines include different capabilities in extracting metadata;
determining which engine in the plurality of engines has a capability to extract metadata from the content; and
sending the content to the determined engine to allow metadata to be extracted from the content.

2. The method of claim 1, further comprising:
receiving the list of capabilities for the plurality of engines; and
generating a graph organizing the list of capabilities, the graph usable to determine which engine has the capability to extract the metadata.

3. The method of claim 1, further comprising:
receiving the content and extracted metadata from the determined engine;
determining a second engine to extract second metadata from the content; and
sending the content to the second engine for extraction of the second metadata.

4. The method of claim 3, wherein the second engine is located in a second device separate a first device that includes the first engine.

5. The method of claim 1, further comprising generating an interconnection flow to coordinate the extraction of metadata among multiple engines in the first device, second device, or a third device.

6. The method of claim 1, wherein the engine is found in a second device different from a first device that is storing the content.

7. An apparatus configured to coordinate extraction of metadata from content, the apparatus comprising:
storage for content;
a coordinator configured to:
determine a list of capabilities for a plurality of engines, wherein engines include different capabilities in extracting metadata;
determine which engine in the plurality of engines has a capability to extract metadata from the content; and
send the content to the determined engine to allow metadata to be extracted from the content.

8. The apparatus of claim 7, further comprising the determined engine to extract the content.

9. The apparatus of claim 7, wherein the determined engine is found in a second apparatus different from the first apparatus.

10. The apparatus of claim 9, wherein the second apparatus includes a capability to extract the metadata but the apparatus does not include the capability.

11. The apparatus of claim 7, wherein the coordinator generates an interconnection flow to coordinate the extraction of metadata among multiple engines in the first apparatus, second apparatus, or a third apparatus.

12. The apparatus of claim 7, wherein the coordinator is configured to:
receive the list of capabilities for the plurality of engines; and
generate a graph organizing the list of capabilities, the graph usable to determine which engine has the capability to extract the metadata.

13. The apparatus of claim 7, wherein the coordinator is configured to:
receive the content and extracted metadata from the determined engine;
determine a second engine to extract second metadata from the content; and
send the content to the second engine for extraction of the second metadata.

14. The apparatus of claim 13, wherein the second engine is located in a second apparatus separate a first device that includes the first engine.

15. A system configured to extract metadata, the system comprising:
a first device comprising:
one or more engines including a first set of capabilities configured to extract first metadata;
a second device comprising:
storage for content; and
a coordinator configured to:
receiving the first set of capabilities from the one or more engines of the first device;
determine a list of capabilities for the one or more engines;
determine which engine in the one or more engines has a capability to extract metadata from the content; and
send the content to the first device to allow the determined engine to extract metadata from the content.

16. The system of claim 15, wherein the second device further comprises one or more second engines including a second set of capabilities for extracting metadata that are different from the first set of capabilities.

17. The system of claim 15, wherein the coordinator generates an interconnection flow to coordinate the extraction of metadata among multiple engines in the first device, second device, or a third device.
